(19) United States
(12) Patent Application Publication
(10) Pub. No.: US 2008/0116252 A1
(43) Pub. Date: May 22, 2008

(54) Storage box capable of separating food from soup

(76) Inventor: Yi-Chen Chou, Taipei (TW)

Correspondence Address: YI-CHEN CHOU, 235 Chung - Ho, Box 8-24, Taipei, omitted

(21) Appl. No.: 11/601,830

(22) Filed: Nov. 20, 2006

(51) Int. Cl. B65D 5/44; A23N 1/00; B65D 17/34; B65D 5/42

(52) U.S. Cl. 229/164.2; 99/495; 229/240; 229/120

(57) ABSTRACT

A storage box capable of separating food from soup comprises a water proof hollow box made of a paper cardboard for storing wet food. The paper cardboard is a further comprises a substrate layer provided with a protective insulating layer for preventing the infiltration of water and germs. There is further a water filtering layer on predetermined location on a surface of the protective insulating layer, whereby the food and the soup can be separated when the carton box is torn properly. It can also added with a tearing piece adjacent to the water filtering layer, whereby the filtering layer will automatically eject soup from the box through when the tearing piece is torn.

### FIELD OF THE INVENTION

The present invention relates to food storage boxes, more particularly to a food storage box capable of removing dripping water before being opened.

### BACKGROUND OF THE INVENTION

It is known that food such as tofu, vegetables, fruits, cooked meats and seafood should be kept in soup for preserving the original flavors and lengthening the period of preservation. If kept in plastic food storage containers, the preservation time will not be long and a freezer is necessary. Therefore, this type of food cannot be brought with mountaineers. For long-time outdoor activities, people often carry dried food and canned food.

However, food kept in iron cans is easy to be contaminated with a rust order due to oxidation on the inner wall of the cans. Further, opening an iron can is troublesome and sometimes dangerous. It is a further disadvantage that iron cans should be recycled; otherwise they will pollute the environment. Extra cost should be added to canned food for recycling the cans.

To solve the above-mentioned problems, a plurality of food storage boxes, made of a variety of materials, are invented, such as the invention “NON-FOIL BARRIER LAMINATES” disclosed by R.O.C. patent number 200305508, the one “PAPERBOARD LAMINATE FOR FOOD PACKAGING APPLICATIONS” disclosed by R.O.C. patent number 200607712 and the one “MOISTURE VAPOR BARRIER LAMINATE” disclosed by R.O.C. patent number 200611825. All of them have a hollow box folded by a laminate material.

However, no matter what kind of food storage boxes, there exists a common problem of complex opening procedure. It is another problem that that the conventional boxes cannot separate food from its soup easily during the opening process. Sometimes it is necessary to use a hand to block the food from the soup when pouring the soup out, which may contaminate the food. The food is usually a bulk, since chopping the food into small pieces will make the food-soup separation more difficult, which will cause trouble in later treatment.

In other words, to separate soup form food upon opening is not effective in the food storage box of the prior art. The present invention will be a food storage box capable of removing dripping water before being opened.

### SUMMARY OF THE INVENTION

The primary objective of the present invention is to provide a storage box capable of separating food from soup wherein there is a filter layer on the box that can effectively separate the food and its soup. The food storage box further includes a protective insulating layer for preventing the infiltration of water, germs and UV light. It does not need a tool to open and recycling; the box will be decomposed in the natural environment automatically, without polluting it.

Accordingly, the present invention, comprises a water proof hollow box for storing wet food, which is made by folding a carton material. The carton material further comprises a substrate layer provided with a protective insulating layer for preventing the infiltration of water and germs. There is further a filtering layer, whereby the food and the soup can be separated when the carton box is torn properly.

Thereby, the above-mention art has the following advantages: (1) extending the preservation time and original flavors; (2) simplifying the opening/separating process for facilitating later cooking; and (3) empty box decomposed naturally in the environment.

The various objects and advantages of the present invention will be more readily understood from the following detailed description when read in conjunction with the appended drawings.

### BRIEF DESCRIPTION OF THE DRAWINGS

FIG. 1 is a perspective view of the present invention as a storage box capable of separating food from soup.

FIG. 2 is an exploded perspective view of the storage box capable of separating food from soup In FIG. 1.

FIG. 3 is a cross-sectional view of the paper cardboard of the second preferred embodiment of the present invention as a storage box capable of separating food from soup.

FIG. 4 illustrates a configuration of the water-filtering layer of the second preferred embodiment.

FIG. 5 illustrates another configuration of the water-filtering layer of the second preferred embodiment.

FIG. 6 is a perspective view of the first preferred embodiment of the present invention.

FIG. 7 is a perspective view of the third preferred embodiment of the present invention.

FIG. 8 illustrates the process of the water-filtering of the present invention.

FIG. 9 is a figure for illustrates the process of pouring out the food pieces.

FIG. 9A is another figure for illustrates the process of pouring out the food pieces.

FIG. 10 is the third present invention of the present invention wherein the tearing tongue and the water-filtering layer are separated.

FIG. 11 is an exploded view of the present invention showing the unfolded structure of a storage box capable of separating food from soup.

FIG. 12 is a perspective view of the present invention having tearing strings.

FIG. 13 shows a preferred embodiment of present invention having tearing strings.

### DETAILED DESCRIPTION OF THE PREFERRED EMBODIMENTS

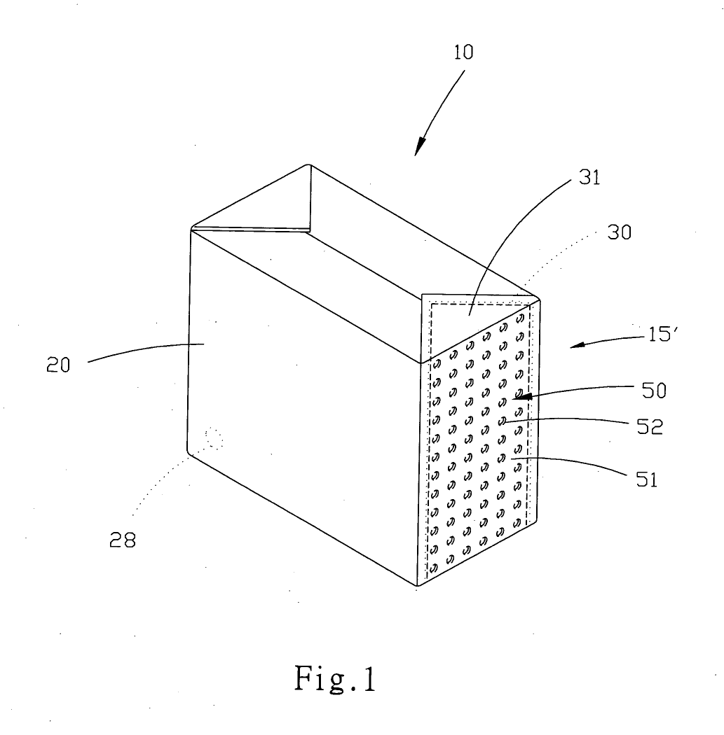

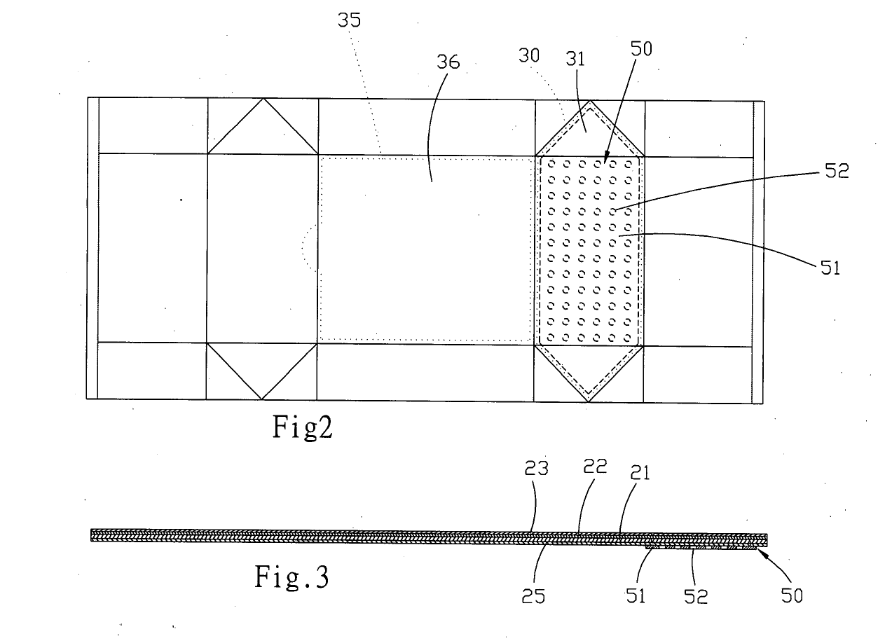

Referring to FIGS. 1 and 2, a storage box capable of separating food from soup comprises a hollow box 10 made of a piece of paper cardboard 20 by folding and gluing and a water-filtering layer 50 attached to the inner surface of the box 10 that can block an openings 15, 15′ of the box 10 formed. Therefore, when the hollow box 10 is torn open, it is easy to separate soup form food pieces in the hollow box 10.

Please see FIGS. 1-3 for a preferred embodiment of the present invention, wherein the paper cardboard 20 of the box 10 further includes a substrate layer 21 made of a thick piece of paper of a multiple paper layer. The outer surface of the substrate layer 21 is coated with a printing layer 22 for carrying decorative patterns and words. The printing layer 22 is further coated with a water-proof film capable of resisting UV light.

The inner surface of the substrate layer 21 is coated with a protective dividing layer 25 made of nano-meter paper, paper with a surface layer of nano paste, botanical fiber paper, plastic film made of protein material, aluminum foil, titanium-rich paste or bamboo-carbon paper, whereby both water and UV light can be effectively blocks. The protective dividing layer 25 can be easily decomposed in the environment and therefore environment-friendly. The water-filtering layer 50 is made of a dividing film 51 and a dividing net 52, both having a multitude of holes smaller than the food pieces in the box 10. When an opening on the box 10 corresponding to the water-filtering layer 50 is torn open, the soup in the box 10 can be poured out quickly, achieving food-soup separation. The paper cardboard 20 further includes an area of ventilating holes 28 on a location other than where said water-filtering layer 50 is, for preventing suction due to decreasing inner pressure during soup-food separation.

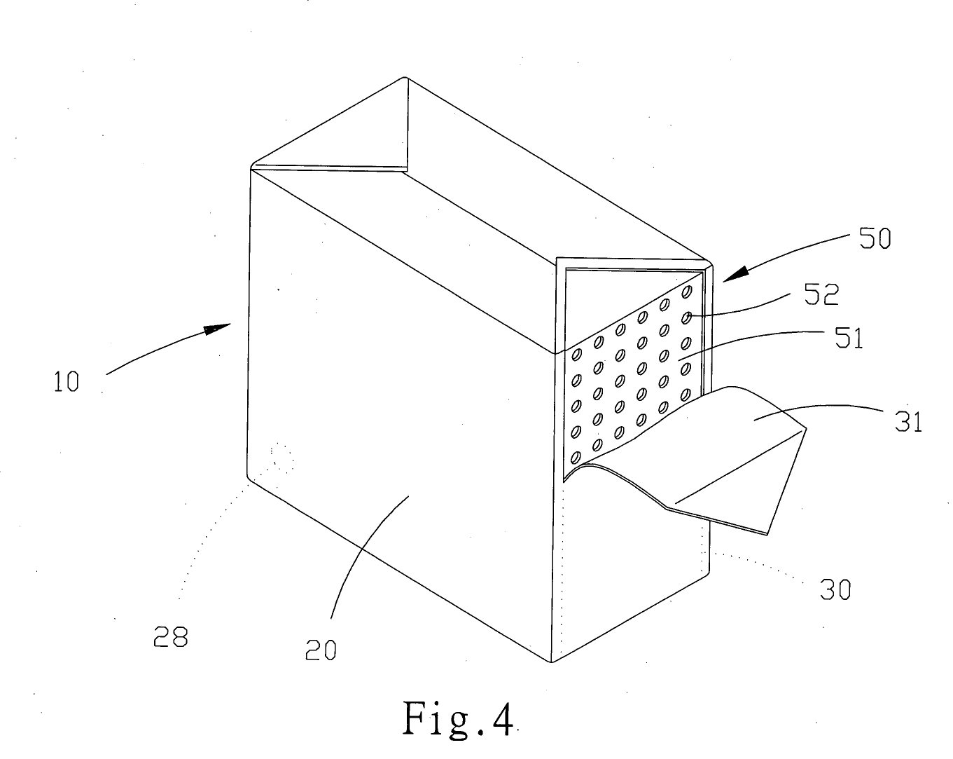

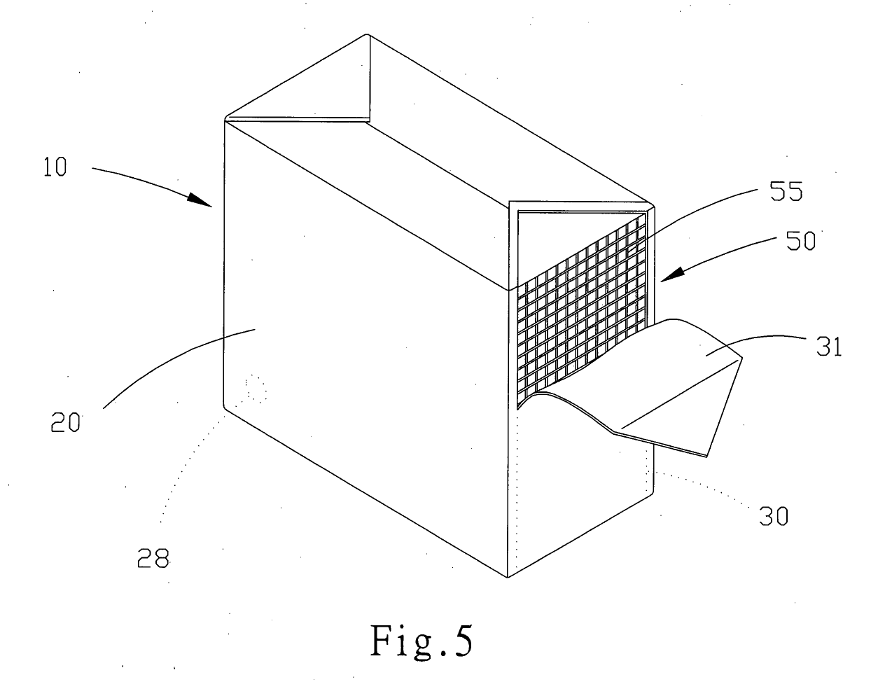

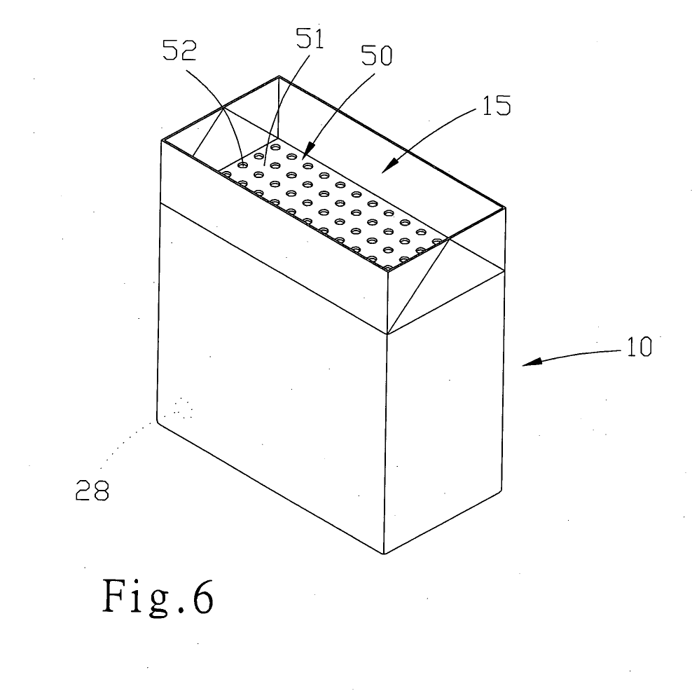

Further, referring to FIGS. 1, 4, and 5, the paper cardboard 20 further includes a tearing line 30 of depth close to the top surface of the water-filtering layer 50 and formed by punching. The tearing line 30 further includes a tearing tongue 31, which will be separated from the water-filtering layer 50 when the box 10 is torn open. Thereby, the soup in which the food pieces marinated can be poured out of the box 10 easily.

Thereby, an efficient means of soup-food separation will be achieved, and therefore the preservation of said food pieces will be much extended.

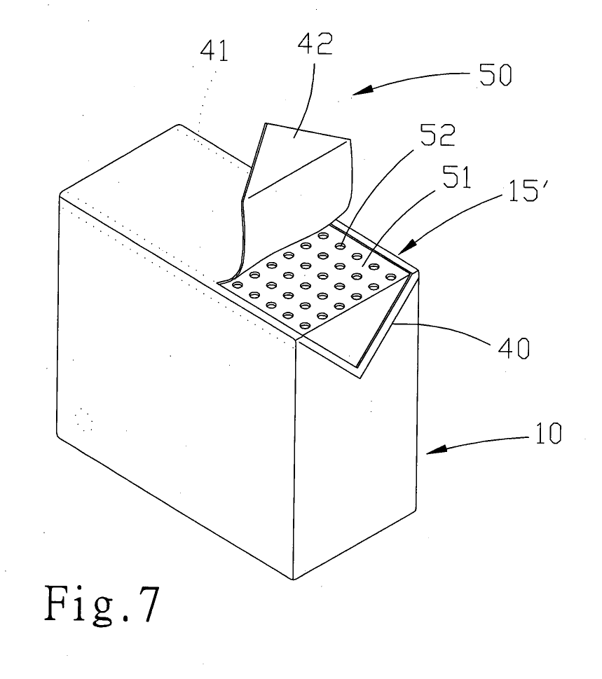

Referring to FIG. 7, the second preferred embodiment of the present invention as a storage box capable of separating food from soup comprises a box 10 and a water-filtering layer 50. The opening 15′ on the box 10 is attached by a covering piece 40 with a surface area larger than the water-filtering layer 50. The covering piece 40 has an inner tearing line 41 circled around the water-filtering layer 50 and a tearing tongue 42 for facilitating the separation of the covering piece 40 from the water-filtering layer 50.

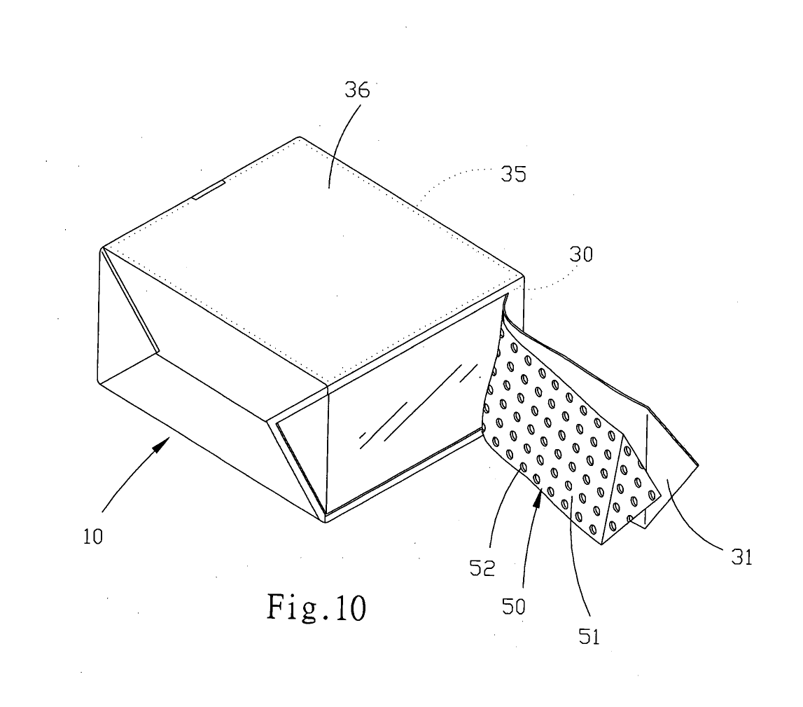

Referring to FIG. 10, in the third preferred embodiment, the tearing tongue 31 of the box 10 has a two-step departure from the box 10. Therefore, the food and the soup therein can be consumed twice.

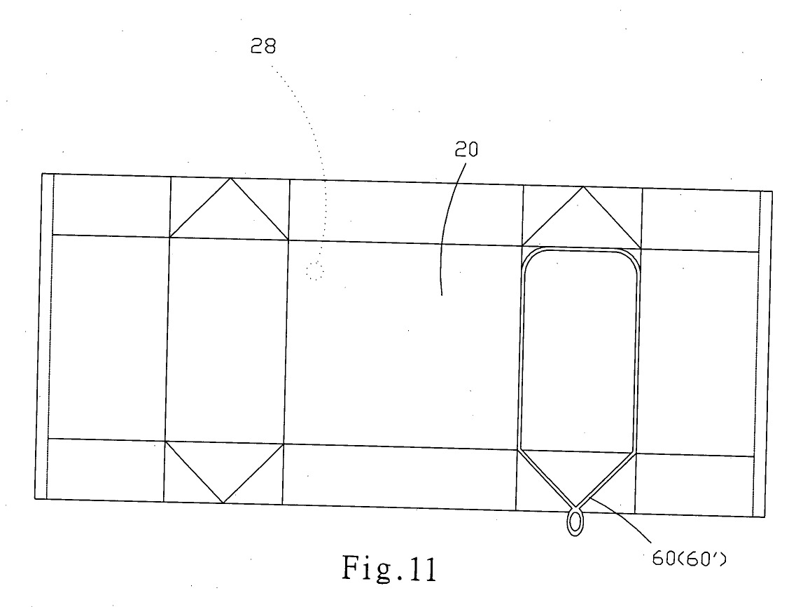

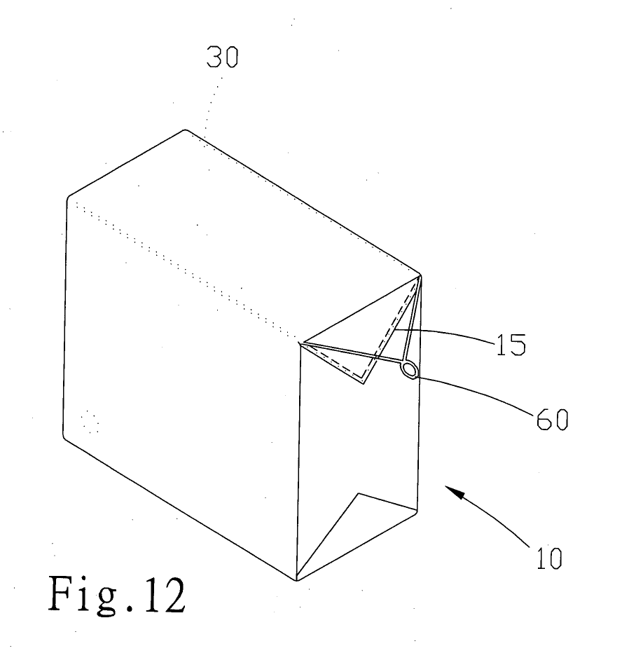

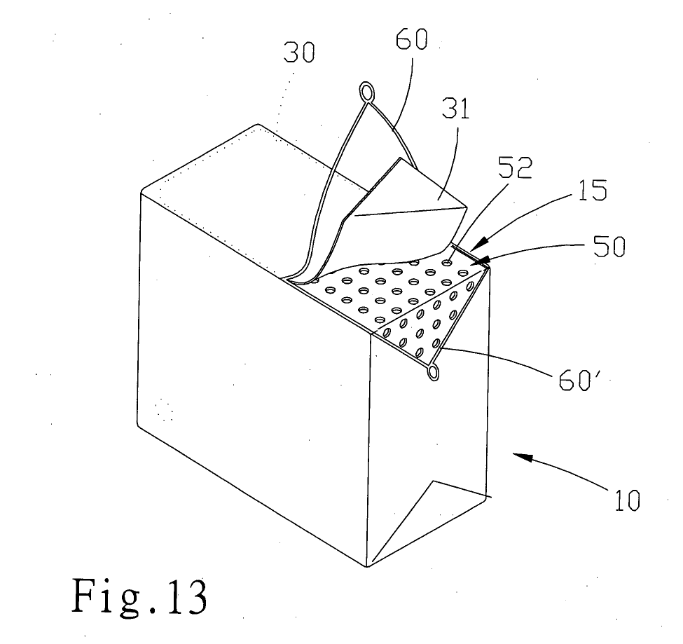

Referring FIGS. 11-13, the fourth preferred embodiment of the present invention has a tearing guide string 60 embedded within the paper cardboard 20. Another tearing guide string 60′ is located around the rim of the water-filtering layer 50, whereby the pulling of both tearing strings 60 and 60′ will open the paper cardboard 20 and the water-filtering layer 50 and whereby the tearing tongue 31 and the water-filtering layer 50 will separate for a quick separation of the food and the soup. Therefore, those tearing strings will accelerate the opening of the box 10.

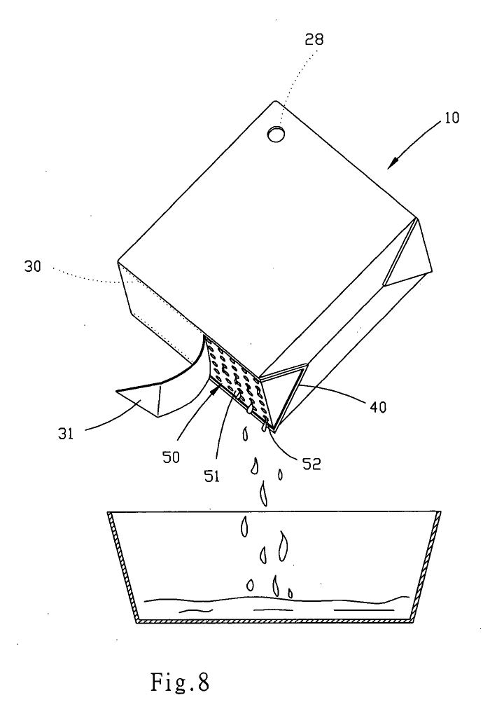

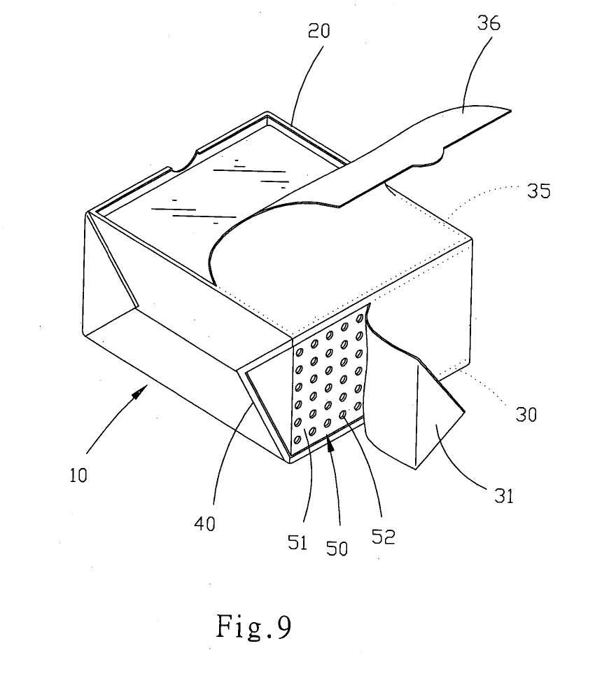

To use the present invention, a user firstly pulls a tearing string 30 that corresponds to the tearing tongue 31 above the water-filtering layer 50 on the cardboard 20, as shown in FIGS. 1, 7 and 8. The area of ventilating holes 28 on the box 10 will facilitate the food-soup separation by preventing negative inner pressure in the box 10 (FIG. 8). After the soup has poured out completely, the user continue to tear the tearing strings 35, 30 till a box cover 36 or the water-filtering layer 50 is removed (FIG. 9). The food without soup will be poured out (FIG. 9A).

To summarize, the design described above has at least the following advantages:

1. There is a protective layer 25 on the inner surface of the paper cardboard 20 of the box 10, which is made of a material selected from nano paper, protein paper and titanium-rich paper, whereby the box 10 is capable of resisting the infiltration of water, germs and UV light. Further, the present invention can store wet food, such as tofu, for extended period of time without a freezer.

2. Because of the long-term preservation without cooling, the storage box is highly portable, best suiting outdoor activities. Further, there is a pre-formed tearing line on the box by which a user can easily open without a tool. The storage box can also be used in emergent food storage.

3. Further, the storage box is environment-friendly since it's materials can be decomposed in the environment.

4. Since food being marinated in soup is allowed, the original flavors of food can be maintained; it will also not be polluted in the process of oxidization.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A storage box capable of separating food from soup, comprising:
a hollow box made of a piece of paper cardboard by folding and gluing, said paper cardboard being a substrate layer with an inner protective dividing layer and an outer printing layer that is further covered by a water proof film;
a water-filtering layer attached onto a surface of said substrate layer that can block an opening of said hollow box formed when said hollow box is torn open for facilitating fast separation of soup from food pieces in said hollow box;
wherein said protective dividing layer is selected from nano-meter paper, paper with a surface layer of nano paste, paper film made of botanical fibers, plastic film made of protein material, aluminum foil, titanium-rich paste and bamboo-carbon paper;
wherein said water-filtering layer is selected from a dividing film a dividing net. both having a multitude of fine holes; and
wherein said water-filtering layer is further provided with a tearing string at a predetermined location around an outer rim thereof for facilitating the tearing of said water-filtering layer.

2-3. (canceled)

4. The storage box capable of separating food from soup of claim 1 wherein said paper cardboard further including an area of ventilating holes on a location other than where said water-filtering layer is located for preventing suction due to decreasing inner pressure during soup/food separation.

5. The storage box capable of separating food from soup of claim 1 wherein said paper cardboard further includes a tearing contour adjacent to a top boundary of said water-filtering layer and corresponding to the outer rim of said water-filtering layer; said tearing contour further includes a tearing tongue.

6. (canceled)

7. The storage box capable of separating food from soup of claim 5 wherein said tearing contour is further provided with a tearing string for facilitating the tearing of said tearing contour and said tearing tongue.

8. The food storage box capable of separating food from soup of claim 1 wherein said paper cardboard 20 further includes an opening tearing line at a location other than where said water-filtering layer is located whose surrounding area has a box cover 36.

9. The storage box capable of separating food from soup of claim 1 wherein said water-filtering layer is attached around an outer rim of an opening of said hollow box and further covered by a covering piece with an area larger than said water-filtering layer 50; said covering piece having an inner tearing line encircling said water-filtering layer for facilitating a separation of said covering piece 40 from said water-filtering layer.
